(19) United States
(12) Patent Application Publication
(10) Pub. No.: US 2017/0165577 A1
(43) Pub. Date: Jun. 15, 2017

(54) Augmented Fantasy Game Systems and Processes Pertaining to - Physiological Movements, Ratings, Bonus Points, Avatars, and Virtual Worlds

(71) Applicant: Nathan Carr, Makawao, HI (US)

(72) Inventor: Nathan Carr, Makawao, HI (US)

(21) Appl. No.: 15/375,083

(22) Filed: Dec. 11, 2016

Related U.S. Application Data
(60) Provisional application No. 62/267,297, filed on Dec. 15, 2015.

(51) Int. Cl. A63F 13/65; A63F 13/335; A63F 13/332; A63F 13/426; A63F 13/828; A63F 13/58; A63F 13/92; A63F 13/795; A63F 13/798; A63F 13/816; A63F 13/2145; A63F 13/46

(52) U.S. Cl. CPC A63F 13/65; A63F 13/2145; A63F 13/335; A63F 13/332; A63F 13/426; A63F 13/46; A63F 13/58; A63F 13/92; A63F 13/795; A63F 13/798; A63F 13/816; A63F 13/828; A63F 2300/1031; A63F 2300/1075; A63F 2300/204; A63F 2300/407; A63F 2300/552; A63F 2300/5553; A63F 2300/5566; A63F 2300/558; A63F 2300/5593; A63F 2300/6045; A63F 2300/69; A63F 2300/8005; A63F 2300/8052

(57) ABSTRACT

A complete augmented fantasy game system (including all supporting processes), which combines the traditional integration of real-life events within fantasy games with an additional bonus competition. A Participant creates a team composed of real-life Competitors. When an owned, real-life Competitor completes a key event, a bonus stage is initiated. The bonus stage enables a Participant to compete directly with an opponent for bonus points. New inventions pertaining to Participant Ratings/rankings and tournament implementation are also claimed.

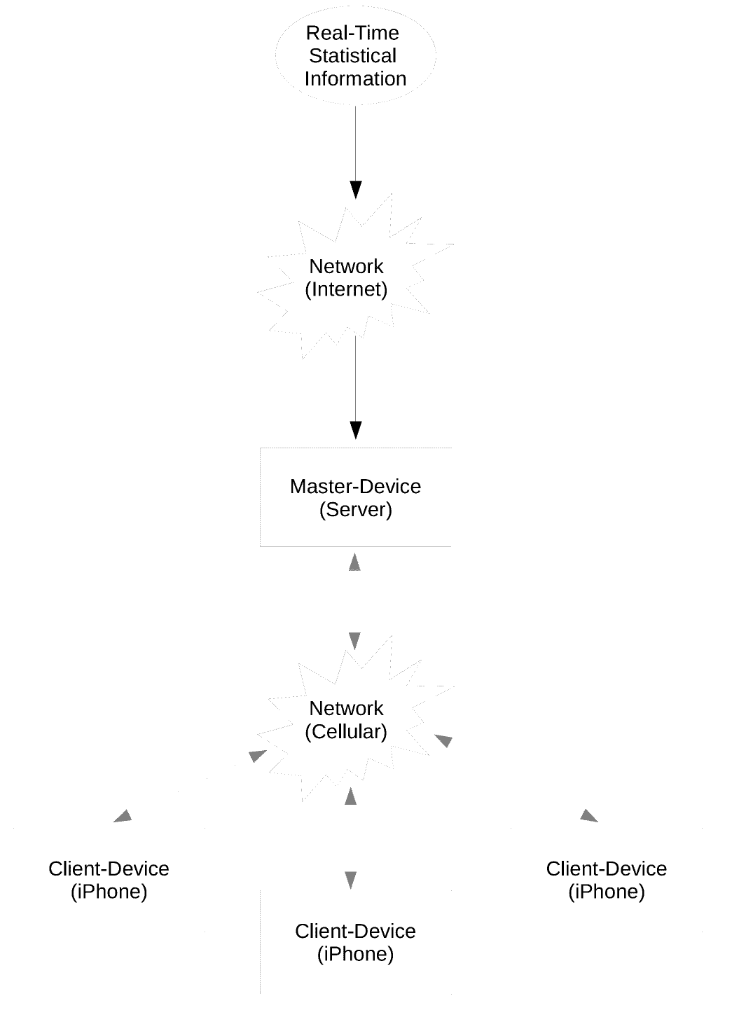

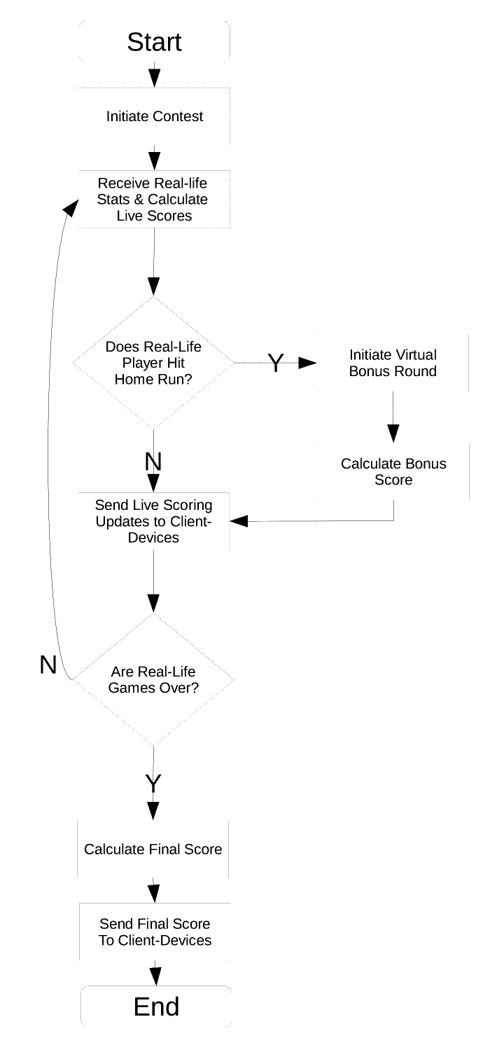

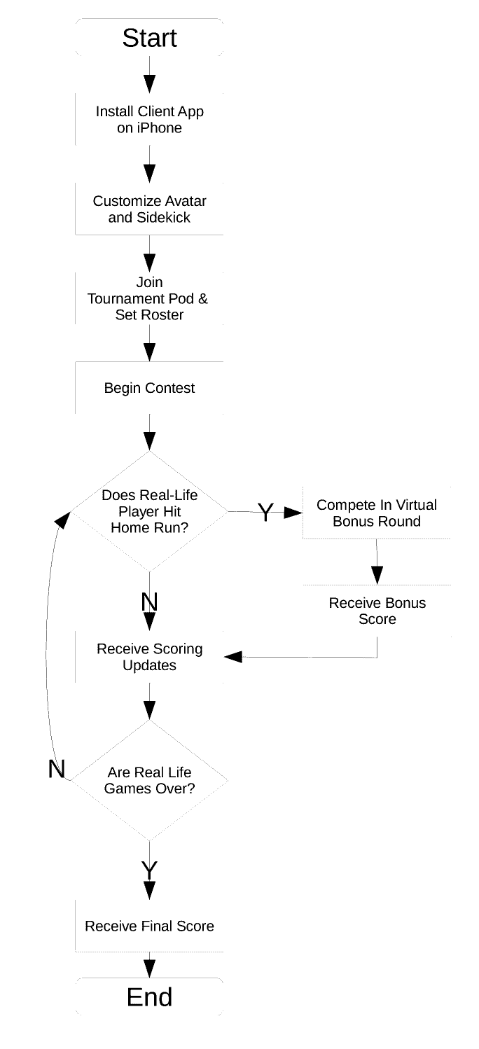

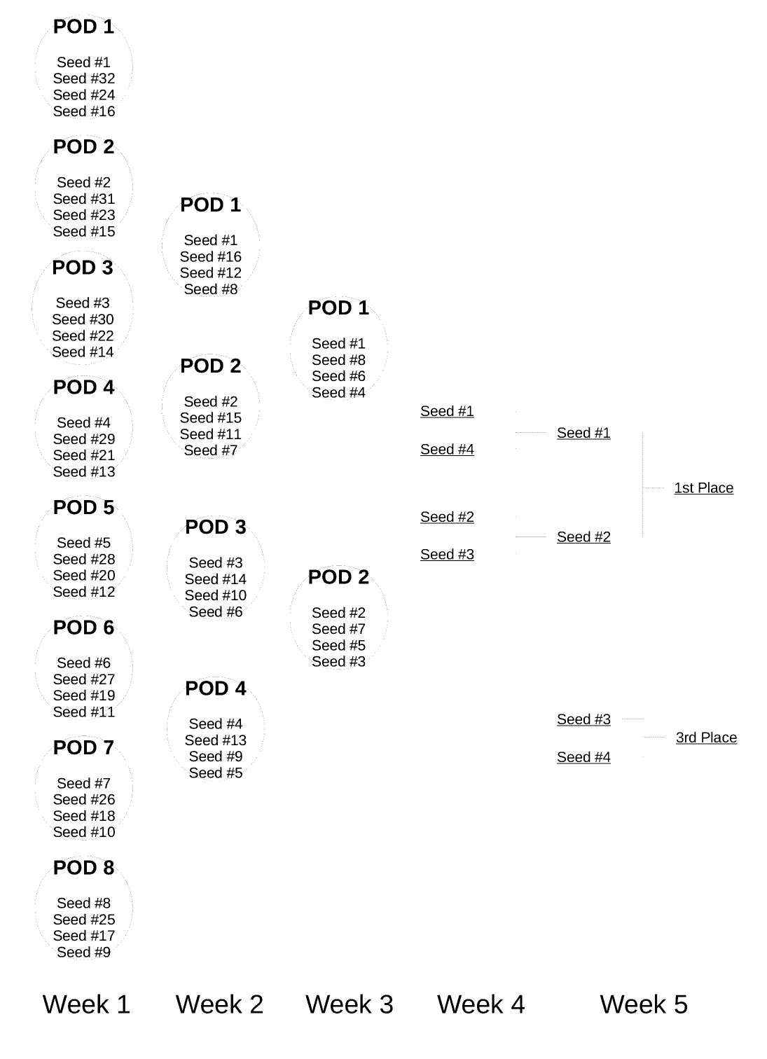

### CROSS-REFERENCE TO RELATED APPLICATIONS

Provisional Application No.: 62/267,297

Filed on Dec. 15, 2015

### PREFACE

It is to be understood that an average citizen is absolutely not legally required to know and/or anticipate the arbitrary specifications and/or rulings of any government employee concerning whether or not this application (or subsequently approved patent) conforms to some irrelevant or vague specification and/or interpretation. The validity of any current or future claims made by the inventor will be solely determined by the law stating, “Whoever invents or discovers any new and useful process, machine, manufacture, or composition of matter, or any new and useful improvement thereof, may obtain a patent. . . . ”

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention can be roughly classified within a new hybrid industry consisting of computer video games and fantasy games, which is now defined by the inventor as ‘Augmented Fantasy’. The relevant arts include software engineering, database architecture, network architecture, logic engineering, project management, game design, video game design, fantasy sports game design, and data science.

### Fantasy Game:

Because the invention represents a new industry (Augmented Fantasy), there are few comparisons. The developers at Vulcun created a game perpetuating violence, which awkwardly combines minimal elements of role-playing games with fantasy eSports. There is no known embodiment of a fantasy sports system that integrates elements of role-playing games (RPG's) into a user controlled avatar within a virtual world. There is no known embodiment of a fantasy scoring system that combines the analytical requirements of fantasy sports with the Physiological Movements of video games. There is no known fantasy sports scoring system that is affected by a Participant's reputation points.

https://vulcun.com/

### Rating:

Ranking processes are the norm for skilled contests like chess. Yannis Sismanis and Jeff Sonas invented a superior chess Rating process; however, this process cannot be directly applied to fantasy games. There have been no methods of applying sub-processes that are a function of the margin of victory and a comparison of scoring against the entire population of Participants.

For daily fantasy sports (DFS), the most popular ranking process is produced by the knaves at RotoGrinders. Not surprisingly, their farce of a process is largely based upon a previous iteration designed to rank poker Competitors. There is an improved, but still rudimentary, fantasy sports ranking process used by the programmer's at Yahoo. The deficiencies in these processes are plainly obvious to one skilled in the arts of logic science, game design and data science. The DFS ranking creators have never fathomed a process to rank Participants using their relative standings for each individual competition. Additionally, no one has created a ranking system to accurately evaluate competitors in Augmented Fantasy, because this document is the first time Augmented Fantasy has been introduced to the public.

There is no known fantasy Rating process that accurately Rates individual Participants based on their aggregated lifetime competition results. There is no known fantasy game system that then allows the Participants to, once they have an accurate Rating, make informed opponent selection decisions based on this accurate Rating system.
https://rotogrinders.com/pages/rotogrinders-rankings-faq-158
http://profiles.sports.yahoo.com/profile_help#archive
http://blog.kaggle.com/wp-content/uploads/2011/02/kaggle_win.pdf

### Tournament:

In the 2012 Olympics, there was a badminton tournament format that consisted of a group round followed by multiple elimination rounds. A scandal resulted due to Participants making intentional efforts to lose. Two reasons this happened was a lack of an accurate Rating system for group play and the use of current tournament results to seed subsequent rounds.

This invention replaces the older tournament models. Competitors are always seeded each round according to previously established Ratings (for example lifetime Ratings). An objective Rating system also gives a more accurate, less predictable evaluation of Participant performance when compared to the more traditional process of counting wins and losses (“less predictable” referring to a Competitor's ability to predict whether ‘throwing a game’ would benefit them in the future seeding process). In addition, there is no known fantasy sports system that determines a seasonal champion using a pod-based tournament process.

https://en.wikipedia.org/wiki/Badminton_at_the_2012_Summer_Olympics_%E2%80%93_Women%27s_doubles

### Definitions

Augmented Fantasy Sports: Traditional fantasy sports integrated with real-time Participant interactions, which directly affect the outcome of the fantasy game.

Client-Device: A Computing Machine that contains a Client-System.

Client-System: A non-volatile, non-transitory storage medium (usually electronic in nature and usually an intricate part of a Computing Machine) embedded with software processes and sub-systems (pre-installed or post installed) with the additional limitation of being specialized for a Participant. Examples of storage mediums include (but are not limited to), computer hard drives, solid-state storage drives (including flash storage within smartphones), portable flash drives, compact discs, and non-human biological storage mediums (including DNA digital data storage).

Competitor: A single individual or group of individuals who, individually or as a group, attempt to achieve a common goal before an opposing individual or group of individuals are able to achieve that same goal. Examples include (but are not limited to) celebrities competing for fame, politicians competing for votes, athletes competing for wins.

Computing Machine: An apparatus, usually electronic in nature, consisting of 2 or more interactive components that produce an effect when energy is applied. Examples include (but are not limited to) computer servers, personal computing devices (including smartphones), video game systems, virtual reality systems, motion sensing systems, and board games.

Master-Device: A Computing Machine that contains a Master-System.

Master-System: A non-volatile, non-transitory storage medium (usually electronic in nature and usually an intricate part of a Computing Machine) embedded with software processes and sub-systems (pre-installed or post installed). Examples of storage mediums include (but are not limited to), computer hard drives, solid-state storage drives (including flash storage within smartphones), portable flash drives, compact discs, and non-human biological storage mediums (including DNA digital data storage).

Participant: A real-life individual who interacts with a Computing Machine. For example, a user who downloads instructions to convert their smartphone into a Client-System.

Physiological Movements: Any internal (or external) action(s) resulting from biological processes of the human body and usually expressed as physical movements. Examples include (but are not limited to) mimicking the motion of swinging a baseball bat, pressing the button on a game controller, moving eyes from side to side, directing neurons in the brain to conceive the motion of swinging a baseball bat, and, preferably, moving a finger on a touchscreen.

Rating: An objective measure used to accurately determine a Participant's relative skill level by processing the results of one or more competitions. All Ratings are rankings, but not all rankings are Ratings.

### BRIEF DESCRIPTION OF THE ATTACHED DRAWINGS/DIAGRAMS

D1) An overview of the preferred embodiment of the fantasy game (including items not within the system).

D2) A generalized example of the preferred embodiment of the bonus round process for a Master-Device.

D3) A generalized example of the preferred embodiment of the fantasy game for a Client-Device.

D4) An example of the preferred embodiment of The Invitational pod tournament process (IF all higher seeds were to defeat the lower seeds).

### SUMMARY OF THE INVENTION

The invention consists of a fantasy game system Master-Device, which acts as a server of a fantasy game. One or more Participants use a Client-Device to access this fantasy game system server by communicating through a wireless or wired network (see D1). Preferably, a virtual world is created from scratch or created with a gaming engine (for example, Unity). The virtual world (linear or open) consists of locations (real-life or imaginary) where the Participants will have the opportunity to interact with each other through a customized avatar of their choosing.

Upon registering, a Participant will have the opportunity to select and customize the avatar (see D3). The Participant accesses a lobby area, which allows the selection of at least one opponent or tournament. Within the lobby, Participants can be filtered by various attributes, which are stored in a Participant database. The Participant database may include fields for rating, reputation, gender, location, affiliations, interests, and much more. Upon selecting an opponent and/or competition, the Participant is directed to populate a fantasy roster consisting of real-life Competitors.

The Participant's fantasy roster accumulates points when the selected real-life Competitors complete events. Upon the completion of a key event by a real-life Competitor, the Master-Device transmits a notification to the Participant's Client-Device. The Client-Device displays the Participant's avatar within the virtual world. The Participant must then directly compete with an opponent in a virtual competition that requires the use of Physiological Movements. Upon completion of the virtual bonus round process, the fantasy game system will determine a bonus round winner. The bonus round winner will then receive bonus points that are directly applied to their fantasy point accumulation (see D2).

The Participant with the highest accumulated point total within a predetermined time-frame is the contest winner. Upon completion of the contest, all Participants' reputation points, experience points, overall Rating and pod Rating (if necessary) are recalculated and points and/or prizes are distributed.

### PREFERRED EMBODIMENT

1) A Participant downloads a fantasy baseball game system client application from a computer server to their smartphone (possibly an iOS based iPhone) [see D3].

2) The Participant installs the client application on their iPhone at no charge.

3) The Participant is assigned a unique ID by the server.

4) The Participant is prompted to upload a picture, which will be used as a basis for their customized avatar.

5) The Participant uploads a picture of themselves to the server.

6) The Participant enters into a virtual room for avatar creation.

7) The Participant customizes their personal avatar, which was created using their photo as a template.

8) The Participant chooses a sidekick for the avatar, which is presented as a baby dragon.

9) The Participant saves their avatar and sidekick onto their client application and the server.

10) The Participant is prompted to begin a tutorial on basic gameplay, which focuses on the gameplay in the virtual world of the bonus round.

11) The Participant partakes in the tutorial, which takes place in a virtual baseball stadium.

12) Upon completion of the tutorial, the Participant is notified of their ‘Cabbage’ status, which indicates their relative Rating.
a) If this account is still unverified, the functionality of the client application is significantly limited.

13) The Participant partakes in multiple batting and/or pitching practice sessions to become more skilled at bonus round gameplay.

14) The Participant completes a registration form, which requires the submittal of their real name, username, postal code they currently reside in, voice id, social security number, mailing address, and electronically signed statement swearing to the validity of the information in the registration form and agreeing to the reasonable terms of participation.

15) The server securely stores the Participant's user information. A real-life individual stores any sensitive information on another machine that is completely cut off from the network and only accessible by directly accessing a physical terminal.

16) The server notifies the Participant's client application that the Participant is now verified.

17) The full feature-set of the client application is enabled. The features include a Participant summary page, a Participant biography page and a self-contained communication system.

18) The Participant activates the lobby screen.

19) The Participant joins a pod of 5 tournament opponents (6 total Participants) before the weekly deadline.

20) The server creates a randomized schedule where the Participant competes against every opponent in the pod.

21) The Participant populates a fantasy roster using real-life MLB players. (The preferred pool of real-life athletes is derived from a real-life sports league of which the games are played every day of the week; in this embodiment, MLB athletes are used.)

22) The fantasy roster consists of 20 athletes (2×C, 2×1B, 2×2B, 2×3B, 2×SS, 6×OF, 2×SP, 2×RP). The Participant can select a maximum of 3 real-life athletes who are playing at the same stadium.

23) Each real-life athlete is assigned a fantasy currency value by the fantasy game system. The total fantasy roster salary is capped at a specific value.

24) The Participant competes against opponent #1 on Monday.

25) If one of the Participant's rostered athletes hits a home run (key event), the server, which is continuously receiving real-time MLB statistical data, sends a wireless notification of this key event to the Participant's client application.
a) The client application produces a visual and audible notification of the eminent bonus round competition.
b) If the Participant fails to acknowledge the impending bonus round within 45 seconds, the server will substitute an artificial intelligence (AI) avatar to compete against the opponent. This AI avatar's skill level is a function of the reputation points accumulated by the Participant. The Participant will receive a small deduction in reputation points for failing to participate in the key event.
c) If the Participant acknowledges the impending bonus round, the server will initiate the bonus round. A virtual baseball stadium will be displayed on the Client-Device. The Participant's avatar is designated at ‘home’. The avatar will display customized effects consistent with a baseball batter. The introduction scenes will display (if available) hitting highlights from previous bonus rounds combined with a musical composition chosen by the Participant (possibly through iTunes).
d) The opponent's avatar will pitch a baseball. The Participant has 3 strikes to hit a home run with their avatar using finger gestures, which not only require the correct timing and motions, but also require an additional finger pressure to be applied appropriately (using the ‘UITouch’ object within iOS is one design possibility).
e) If the Participant hits a home run with the avatar, the Participant receives additional bonus points equivalent to the amount of the standard fantasy points received when the real-life athlete hit the home run.
f) If the Participant swings and misses 3 times, the opponent receives the additional bonus points.

26) If one of the opponent's rostered athletes hits a home run, the server and client application perform a similar process as occurs during a Participant's home run; however, now the Participant's avatar is designated ‘away’. This avatar will display customized effects consistent with a baseball pitcher.
a) The Participant uses finger gestures and pressures to pitch the baseball.
b) The Participant's sidekick will perform fielding duties on the virtual field.
c) If the opponent hits a home run that is defined as ‘close’ by the fantasy baseball game, a function will be called. This function applies a probabilistic formula factoring in the Participant's reputation points. The function returns a value of ‘great_catch’ or ‘home_run’. In the case of a ‘great_catch’, an animation is shown depicting the Participant's Sidekick stealing the home run from the opponent. Bonus points are assigned as previously mentioned.

27) Upon completion of all the real-life games for the day, the server calculates the game winner based on accumulated fantasy points and bonus points. The server then updates the reputation points, experience points, overall Rating and pod Rating (if necessary) for all Participants.

28) The overall Rating consists of two main components. Component 1 is the direct adjustment due to the Participant's bonus points scored verses their opponent. Component 1 is weighted; this weight corresponding to the relative effect the bonus points scored has on the total fantasy points. Component 2 is the adjustment due to a relative comparison of the Participant's base fantasy point score verses the average/median of all contests during the day.

29) The pod Rating (PR) is a modified version of the Overall Rating. PR Component 1 is the direct adjustment due to the Participant's bonus points scored verses their opponents in the pod. PR Component 2 is the adjustment due to a relative comparison of the Participant's base fantasy point score verses the average/median of all the opponents within the Participant's pod.

30) Tuesday through Friday repeats the same processes.

31) After final scores are calculated for Friday, the server eliminates the two lowest Rated teams determined by the pod Rating process. The remaining 4 Participants are seeded according to their Pod Rating.

32) On Saturday, the #1 seed competes against the #4 seed and the #2 seed competes against the #3 seed. The competitions follow the previously outlined processes. The Participant with the highest fantasy point score is the winner.

33) On Sunday, the winning Participants from Saturday compete in the championship contest. The competitions follow the previously outlined processes. After final scores are calculated for Sunday, prizes are awarded to the Participants.

34) The proceeding competitions follow the previously outlined processes until the last 5 weeks of the MLB season. During these last 5 weeks, the top 32 highest Rated Participants are entered into The Invitational tournament.

35) The seeding of The Invitational is based on lifetime Ratings. The Invitational consists of 8 pods composed of 4 Participants (see D4). Pod 1 is composed of the highest seed (higher seed equals lower number) and the lowest seed. Pod 2 is composed of the second highest seed and the second lowest seed. The remaining Pods follow the same pattern. The rest of the Participants are placed one at a time into the pods in descending order by seed number beginning with Pod 1. This process is repeated until there are no Participants left. This process ensures that seeds 1 through 8 (top 25%) are placed in pods where the higher the seed, the lower the seed of their opponents, even after multiple rounds.
a) During week 1, every pod Participant competes against every other member of their pod. The games begin on Friday. Each day's competition is as previously detailed. After the completion of the games on Sunday and the server updates, the 2 Participants in each pod with the lowest Pod Rating are eliminated from the tournament, prizes are awarded, and the other Participants move on to the next round.

b) During week 2, the 16 Participants are divided into 4 pods composed of 4 Participants. The Participants are placed into new pods according to the previously described process. The completion of week 2 follows the previously outlined processes of week 1.
c) During week 3, the 8 Participants are divided into 2 pods composed of 4 Participants. The games are played according to the previously described processes for week 2.
d) During week 4, the 4 Participants are placed into a single elimination tournament according to the previously established seeding process. The Participants compete in a two game series with their one opponent. The first games are on Saturday. The games are played according to the previously described guidelines.
e) During week 5, the winners from the previous week compete for 1st place, while the losers compete for 3rd place. The games are played according to the previously described processes. Upon completion of the games, the server updates the final reputation points, experience points, and overall Rating for the season, then awards the prizes.

36) Throughout the off-season, the Participant participates in ‘training’ events to gain unique competitive advantages for the following season.

### ADDITIONAL EMBODIMENTS

E2) In one embodiment, an unskilled Participant can select entire real-life teams to populate their fantasy roster thus ensuring that their fantasy team will complete key events, which will allow this unskilled Participant to compete in more bonus rounds.

E3) In one embodiment, Participants join a team with multiple Participants. These Participants might share a common attribute, for example an affiliation to an institute of higher learning. This group of Participants will choose to compete against an opposing team of Participants (possibly from a rival institute of higher learning). The Fantasy Sports Game System determines who the ‘home’ team is. The ‘home’ team Participants then collectively determine the individual Participant match-ups. The Participants then compete according to the previously detailed rules of competition; however, at the completion of the contest, all the scores from each team of Participants are aggregated. The team of Participants with the highest aggregate score is determined to be the winner.

E4) In one embodiment, Competitors are selected from the domain of high-school athletes.

E5) In one embodiment, Competitors are selected from the domain of professional athletes from Japan.

E6) In one embodiment, Competitors are selected from the domain of professional soccer players. In the bonus round, the Participant will either be in control of a goalie themed avatar or penalty kicking avatar. The sidekick potentially intervenes if the goal scored is very close. When controlling the goalie, finger gestures don't just control the velocity of the avatar, but supplemental finger gestures also control the arms of the avatar at the same time.

E7) In one embodiment, there is a robust self-contained socializing system for the Participants to use. A sub-system acts as a real-time translator for international Participants who don't speak the same language. Through the system, Participants can act as mentors to those less experienced to earn additional reputation points.

E8) In one embodiment, there is a process that creates a highlight reel of bonus round animations. These animations are displayed similar to the way highlights of real-life athletes might be displayed on a sports news program.

E9) In one embodiment, Competitors are selected from the domain of eSports.

E10) In one embodiment, Competitors are selected from the domain of professional golfers. In the bonus round, the Participant will either be in control of an avatar at a tee or their chosen sidekick. The Participant's avatar chips the ball into the hole while the opponent's sidekick attempts to intercept the ball before it goes in.

E11) In one embodiment, the bonus round consists of a word or logic puzzle that the Participants must solve.

E12) In one embodiment, an avatar is able to navigate the virtual world before, during, and after a bonus round occurrence. The avatar can interact with other avatars. When a key event occurs, the avatar's smartphone rings (this requires the Participant to be logged on during the fantasy competition). The avatar must be directed to a specific location in a limited amount of time.

E13) In another embodiment, the system prints, “How ironic that ordinary attorneys and judges familiar in the art of patent law are unable to interpret said patent laws without undue experimentation, which if said patent laws were applied unto themselves would cause said patent laws to render themselves invalid.”

The invention in which an exclusive right is claimed is defined by the following:

1. A Master-System embedded with processes and subsystems for a fantasy game:
a) One or more Participants
b) The Participants compete by selecting a fantasy team comprised of real-life Competitors
c) The real-life actions of the real-life Competitors participating in real-life events are assigned point values
d) If one or more real-life Competitors completes a key event, the Participants compete directly in a bonus round
e) The actions of the Participants during the bonus round are assigned bonus point values
f) Upon completion of all the real-life events within a time frame, a final score is calculated that is a function of both the base point values and the bonus point values.

2. The Master-System of claim 1 with the additional limitation that the bonus round competition assigns bonus points that are dependent upon the Participant performing Physiological Movements.

3. The Master-System of claim 2 with the additional limitation that the skillful use of finger movements and finger pressure are both required to perform at a high level (compared to an average novice) in bonus round competition.

4. The Master-System of claim 1 with the additional limiting process of using a Participant's reputation points to directly affect how point values are assigned.

5. The Master-System of claim 1 with the additional limiting process of an animated sidekick being associated with a Participant.

6. The Master-System of claim 5 with the additional limiting process of an animated sidekick who's behavior is determined at least partially by a function of the corresponding Participant's reputation points.

7. The Master-System of claim 1 with the additional limitation that a Participant must control an avatar in a virtual world to compete in the bonus round.

8. The Master-System of claim 1 limited to an embodiment as an interactive component in a Master-Device.

9. The Master-System of claim 1 limited to using overlapping fantasy rosters.

10. The Master-System of claim 1 limited to the domain of fantasy sports.

11. The Master-System of claim 1 limited to the domain of fantasy baseball.

12. The Master-System of claim 1 with the additional limitation that it contains sub-processes that are specialized for a Client-Device.

13. The Master-System of claim 1, with the additional limitation of an optional randomizing process:
a) Recording the eligible Participants
b) Counting down to a predetermined time before the start of the relevant real-life events
c) Assigning the Participants to random opponents after completion of the countdown
d) Notifying Participants who their opponent is for the given competition.

14. A process of acquiring a Participant Rating by:
a) Accessing one or more opponent bonus Ratings
b) Accessing the number of Participant bonus competitions
c) Calculating the recency of Participant bonus competitions
d) Calculating the margin of victory of bonus competitions
e) Accessing a Participant's non-bonus points scored in a competition
f) Accessing the number of Participant competitions
g) Calculating the average/median non-bonus score of the set of all corresponding competitions occurring within the same time frame
h) Calculating the recency of Participant competitions
i) Running one or more sub-processes that input the opponent bonus Ratings (14a), the Participant bonus competitions (14b), the recency of Participant bonus competitions (14c), the margin of victory in bonus competitions (14d), the points scored (14e), the Participant competitions (14f), the average/median score (14g), and the recency of Participant competitions (14h)
j) Returning a value for a Participant Rating.

15. The Master-System of claim 1 with the additional limitation that it includes the Participant Rating process:
a) Accessing one or more opponent bonus Ratings
b) Accessing the number of Participant bonus competitions
c) Calculating the recency of Participant bonus competitions
d) Calculating the margin of victory of bonus competitions
e) Accessing a Participant's non-bonus points scored in a competition
f) Accessing the number of Participant competitions
g) Calculating the average/median non-bonus score of the set of all corresponding competitions occurring within the same time frame
h) Calculating the recency of Participant competitions
i) Running one or more sub-processes that input the opponent bonus Ratings (15a), the Participant bonus competitions (15b), the recency of Participant bonus competitions (15c), the margin of victory in bonus competitions (15d), the points scored (15e), the Participant competitions (15f), the average/median score (15g), and the recency of Participant competitions (15h)
j) Returning a value for a Participant Rating.

16. A process of managing a tournament by:
a) Accessing the Participants' Ratings within a given time period
b) Seeding a given number of pods according to the following sub-process:
i) For all seeds without a pod placement, placing the highest seed (higher seed equals lower number) and the lowest seed in the 1st empty pod.
ii) Repeating step (i) until all pods contain two Participants.
iii) Placing the rest of the Participants one at a time into the Pods in descending order by seed number beginning with the first pod and ending with the last pod.
iv) Repeating step (iii) until there are no Participants left
c) Creating a schedule requiring all members of a pod to compete against each other
d) Eliminating a predetermined number of Participants using a predetermined Rating process after completion of the schedule
e) Re-seeding the remaining Participants into pods according to (16b)
f) Repeating the steps (16c), (16d), and (16e) until a predetermined number of Participants remain
g) Creating a single elimination tournament with the remaining Participants, requiring the Participants to compete against each other at least two times.

17. The process of claim 16, with the limitation that the Rating must be calculated by:
a) Accessing one or more opponent bonus Ratings
b) Accessing the number of Participant bonus competitions
c) Calculating the recency of Participant bonus competitions
d) Calculating the margin of victory of bonus competitions
e) Accessing a Participant's non-bonus points scored in a competition
f) Accessing the number of Participant competitions
g) Calculating the average/median non-bonus score of the set of all corresponding competitions occurring within the same time frame
h) Calculating the recency of Participant competitions
i) Running one or more sub-processes that input the opponent bonus Ratings (17a), the Participant bonus competitions (17b), the recency of Participant bonus competitions (17c), the margin of victory in bonus competitions (17d), the points scored (17e), the Participant competitions (17f), the average/median score (17g), and the recency of Participant competitions (17h)
j) Returning a value for a Participant Rating.
